(19) United States
(12) Patent Application Publication
(10) Pub. No.: US 2009/0268658 A1
(43) Pub. Date: Oct. 29, 2009

(54) Apparatus and method for relay service in wireless communication system

(75) Inventors: Young-Bin Chang, Anyang-si (KR); Taori Rakesh, Suwon-si (KR); Hyun-Jeong Kang, Seoul (KR); Jung-Je Son, Yongin-si (KR)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 12/386,914

(22) Filed: Apr. 24, 2009

(30) Foreign Application Priority Data
Apr. 25, 2008 (KR) 10-2008-0039039
Apr. 25, 2008 (KR) 10-2008-0039040

(51) Int. Cl. H04B 7/14

(52) U.S. Cl. 370/315

(57) ABSTRACT

An apparatus and a method for relay service in a wireless communication system are provided. A method for constituting a frame for a relay service in a wireless communication system includes configuring Downlink and Uplink subframes for a Base Station (BS) to transmit and receive signals to and from a Mobile Station via one or more relay stations over one or more communication zones. Thus, the frames for the multihop relay service can be constituted with ease, the multihop relay service can be provided not to drive the relay service data into a particular part of the frame, and the service coverage of the MS can be extended.

### CROSS-REFERENCE TO RELATED APPLICATION(S) AND CLAIM OF PRIORITY

The present application claims the benefit under 35 U.S.C. § 119(a) to a Korean patent application filed in the Korean Intellectual Property Office on Apr. 25, 2008 and assigned Serial No. 10-2008-0039039, a Korean patent application filed in the Korean Intellectual Property Office on Apr. 25, 2008 and assigned Serial No. 10-2008-0039040, the entire disclosure of which is hereby incorporated by reference.

### TECHNICAL FIELD OF THE INVENTION

The present invention relates generally to a wireless communication system which adopts a relay scheme. More particularly, the present invention relates to an apparatus and a method for constituting a frame to provide a multihop relay service in the wireless communication system.

### BACKGROUND OF THE INVENTION

A wireless communication system provides a relay service using a relay station in order to offer a good radio channel to a terminal in a cell boundary or in a shadow area. For example, the wireless communication system relays signals transmitted and received between a base station and a terminal via the relay station as shown in FIG. 1.

FIG. 1 illustrates a conventional wireless communication system for providing the relay service.

The wireless communication system of FIG. 1 includes a Base Station (BS) 100, a Relay Station (RS) 110, and Mobile Stations (MSs) 101 and 111.

The BS 100 communicates directly with the first MS 101 traveling in its service coverage.

The BS 100 services the second MS 111 traveling outside the service coverage via the RS 110. More particularly, by way of the RS 110, the BS 100 services MSs that travel outside the service coverage or in the shadow area and suffer a poor channel status.

The wireless communication system provides the relay service using a frame of FIG. 2.

FIG. 2 illustrates the frame structure for the relay service in the conventional wireless communication system.

The frame of FIG. 2 includes a DownLink (DL) subframe 200 and an UpLink (UL) subframe 210.

The DL subframe 200 of a BS frame 220 includes a DL access zone 202 for sending a signal from the BS to the MS connected through a direct link, and a DL relay zone 204 for sending a signal from the BS to the RS.

The UL subframe 210 of the BS frame 220 includes a UL access zone 212 for receiving a UL signal from the MS to the BS, and a UL relay zone 214 for receiving a UL signal from the RS to the BS.

The DL subframe 200 of an RS frame 230 includes an access zone 202 for sending a signal from the RS to the MS connected through a relay link, and a relay zone 204 for receiving a signal from the BS to the RS.

The UL subframe 210 of the RS frame 230 includes an access zone 212 for receiving a UL signal from the MS to the RS, and a relay zone 214 for sending a UL signal from the RS to the BS.

As stated above, the wireless communication system divides the subframe for the relay service into the access zone and the relay zone.

In a case where the wireless communication system includes multiple hops, the wireless communication system splits the relay zone to a zone for the communication between the BS and the RS and a zone for the communication between the RSs.

As the number of the RSs for relaying the signals between the BS and the MS increases, disadvantageously, the signals are driven into the relay zone.

### SUMMARY OF THE INVENTION

To address the above-discussed deficiencies of the prior art, it is a primary aspect of the present invention to address at least the above mentioned problems and/or disadvantages and to provide at least the advantages described below. Accordingly, an aspect of the present invention is to provide an apparatus and a method for configuring a frame to offer a multihop relay service in a wireless communication system.

Another aspect of the present invention is to provide an apparatus and a method for configuring a downlink subframe to offer a multihop relay service in a wireless communication system.

Yet another aspect of the present invention is to provide an apparatus and a method for configuring an uplink subframe to offer a multihop relay service in a wireless communication system.

Still another aspect of the present invention is to provide an apparatus and a method for distributing data for a relay link service in a wireless relay communication system

A further aspect of the present invention is to provide an apparatus and a method for configuring a frame to distribute data for a relay link service in a wireless relay communication system.

According to one aspect of the present invention, a method for configuring a frame for a relay service in a wireless communication system includes configuring a DL subframe for at a BS to transmit a signal to an MS over a first zone of the DL subframe and to transmit a signal to the MS or a lower RS over a second zone; configuring an UpLink (UL) subframe to receive a signal from the MS over a first zone of the UL subframe and to receive a signal from the MS or the lower RS over a second zone; configuring a DL subframe for an odd-hop RS to transmit a signal to an MS or a lower even-hop RS over a first zone of the DL subframe and to receive a signal from an upper node over a second zone; configuring a UL subframe to receive a signal from an MS or a lower even-hop RS over a first zone of the UL subframe and to transmit a signal to an upper node over a second zone; configuring a DL subframe for an even-hop RS to receive a signal from an upper node over a first zone of the DL subframe and to transmit a signal to an MS or a lower odd-hop RS over a second zone; and configuring a UL subframe to transmit a signal to an upper node over a first zone of the UL subframe and to receive a signal from an MS or a lower odd-hop RS over a second zone.

According to another aspect of the present invention, a method for a relay service at an RS in a wireless communication system includes confirming a frame structure to be used to provide a relay service by taking into account of the number of hops to a BS; transmitting, at an odd-hop RS, a signal to an MS or a lower even-hop RS over a first zone of a DL subframe and receiving a signal from an upper node over a second zone according to the confirmed frame structure; receiving a signal from an MS or a lower even-hop RS over a first zone of a UL subframe and transmitting a signal to an upper node over a second zone; receiving, at an even-hop RS, a signal from an upper node over a first zone of a DL subframe and transmitting a signal to an MS or a lower odd-hop RS over a second zone according to the confirmed frame structure; and transmitting a signal to an upper node over a first zone of the UL subframe and receiving a signal from the MS or the lower odd-hop RS over a second zone.

According to yet another aspect of the present invention, a method for a relay service at a BS in a wireless communication system includes confirming frame structures to be used for RSs to provide the relay service by taking into account the number of hops of at least one RS; allocating resources for the RSs by taking into account the frame structures of the RSs; transmitting resource allocation information to the RSs; and communicating with an MS or the RS according to the resource allocation information.

According to still another aspect of the present invention, an apparatus for a relay service at an RS in a wireless communication system includes a scheduler for controlling transmission and reception of signals according to a frame structure determined based on the number of hops to a BS; a receiver for, in an odd-hop RS, receiving a signal from an upper node over a second zone of a DL subframe and receiving a signal from an MS or a lower even-hop RS over a first zone of a UL subframe under control of the scheduler, and, in an even-hop RS, receiving a signal from an upper node over a first zone of the DL subframe and receiving a signal from the MS or a lower odd-hop RS over a second zone of the UL subframe under the control of the scheduler; and a transmitter for, in the odd-hop RS, transmitting a signal to the MS or the lower even-hop RS over the first zone of the DL subframe and transmitting a signal to the upper node over the second zone of the UL subframe under the control of the scheduler, and, in the even-hop RS, transmitting a signal to the MS or the lower odd-hop RS over the second zone of the DL subframe and transmitting a signal to the upper node over the first zone of the UL subframe under the control of the scheduler.

According to a further aspect of the present invention, an apparatus for a relay service at a BS in a wireless communication system includes a frame determiner for confirming frame structures to be used for RSs to provide the relay service by taking into account the number of hops of at least one RS; a scheduler for allocating resources for the RSs by taking into account the frame structures of the RSs; a transmitter for transmitting resource allocation information to the RSs, and sending a signal to an MS or an RS according to the resource allocation information; and a receiver for receiving a signal from the MS or the RS according to the resource allocation information.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a conventional wireless communication system for providing a relay service;

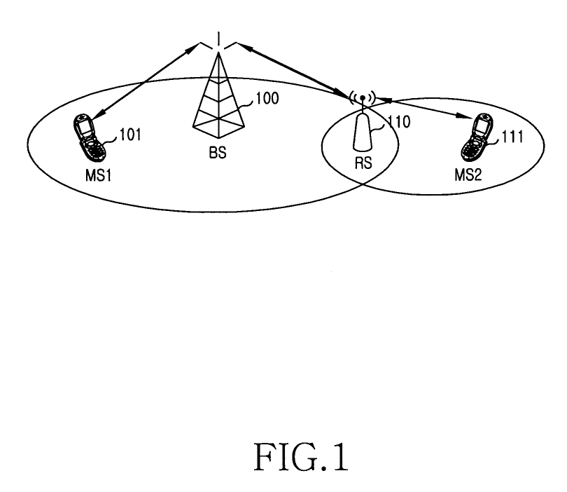

FIG. 2 illustrates a frame structure for the relay service in the conventional wireless communication system;

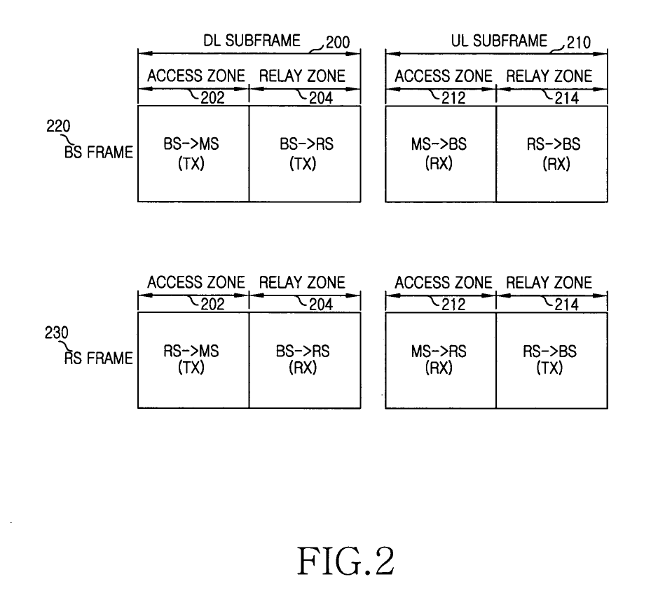

FIG. 3 illustrates a wireless multihop communication system according to an exemplary embodiment of the present invention;

FIG. 4 illustrates downlink subframes for the relay service in the wireless communication system according to an exemplary embodiment of the present invention;

FIG. 5 illustrates downlink subframes for the relay service in the wireless communication system according to another exemplary embodiment of the present invention;

FIG. 6 illustrates uplink subframes for the relay service in the wireless communication system according to an exemplary embodiment of the present invention;

FIG. 7 illustrates uplink subframes for the relay service in the wireless communication system according to another exemplary embodiment of the present invention;

FIG. 8 illustrates operations of a base station for the relay service in the wireless communication system according to an exemplary embodiment of the present invention;

FIG. 9 illustrates operations of a relay station for the relay service in the wireless communication system according to an exemplary embodiment of the present invention;

FIG. 10 illustrates the base station in the wireless communication system according to an exemplary embodiment of the present invention;

FIG. 11 illustrates the relay station in the wireless communication system according to an exemplary embodiment of the present invention;

FIG. 12 illustrates relay station sets in the wireless multihop communication system according to an exemplary embodiment of the present invention;

FIG. 13 illustrates downlink subframes according to the RS sets in the wireless communication system according to an exemplary embodiment of the present invention;

FIG. 14 illustrates uplink subframes according to the RS sets in the wireless communication system according to an exemplary embodiment of the present invention;

FIG. 15 illustrates operations of the base station for the relay service in the wireless communication system according to another exemplary embodiment of the present invention; and

FIG. 16 illustrates operations of the relay station for the relay service in the wireless communication system according to another exemplary embodiment of the present invention.

Throughout the drawings, like reference numerals will be understood to refer to like parts, components and structures.

### DETAILED DESCRIPTION OF THE INVENTION

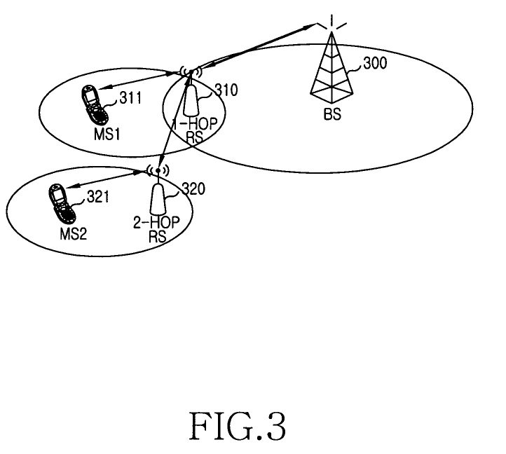

FIGS. 3 through 16, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system.

The following description with reference to the accompanying drawings is provided to assist in a comprehensive understanding of exemplary embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

Exemplary embodiments of the present invention provide a technique for providing a multihop relay service in a wireless communication system.

Hereinafter, the number of hops of a RS is determined by a distance between a BS and the RS. An RS directly communicating with the BS is referred to as a 1-hop RS and an RS communicating with the BS by connecting to the 1-hop RS is referred to as a 2-hop RS. When the wireless communication system includes three or more hops, the 1-hop RS, the 3-hop RS, the (2n−1)-hop RS, and so forth are referred to as odd-hop RSs, and 2-hop RS, the 4-hop RS, the 2n-hop RS, and so forth are referred to as even-hop RSs, where n is an integer greater than 1.

A wireless communication system for providing a relay service can be established in multihop hops as shown in FIG. 3.

FIG. 3 illustrates a wireless multi-hop communication system according to an exemplary embodiment of the present invention.

The wireless communication system of FIG. 3 includes a BS 300, RSs 310 and 320, and MSs 311 and 321.

The BS 300 services the first MS 311 via the 1-hop RS 310. The BS 300 services the second MS 321 via the 1-hop RS 310 and the 2-hop RS 320.

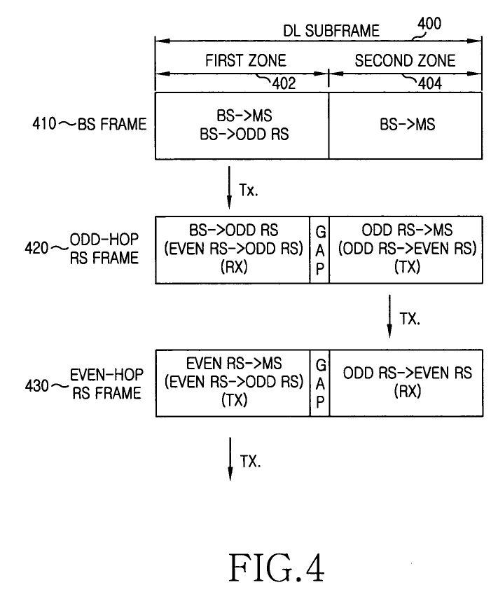

As mentioned earlier, when the wireless communication system includes multiple hops, the wireless communication system offers the relay service using a DL subframe of FIG. 4.

FIG. 4 illustrates the DL subframes for the relay service in the wireless communication system according to an exemplary embodiment of the present invention.

The DL subframe 400 of FIG. 4 is divided to a first zone 402 and a second zone 404 using time resources.

The BS sends a DL signal to an MS directly communicating therewith and a 1-hop RS over the first zone 402 of a BS frame 410.

The BS sends a DL signal to the MS directly communicating, over the second zone 404 of the BS frame 410.

The odd-hop RS receives a DL signal from the BS or an upper RS over the first zone 402 of an odd-hop RS frame 420. For example, in the first zone 402, the 1-hop RS receives a DL signal from the BS and the 3-hop RS receives a DL signal from the 2-hop RS.

In the second zone 404 of the odd-hop RS frame 420, the odd-hop RS sends a DL signal to an MS of the relay service or a lower RS. For example, over the second zone 404, the 1-hop RS sends a DL signal to the 2-hop RS or the MS of the relay service.

An even-hop RS sends a DL signal to the MS of the relay service or the lower RS over the first zone 402 of an even-hop RS frame 430. For example, over the first zone 402, the 2-hop RS sends the DL signal to the 3-hop RS or the MS of the relay service.

The even-hop RS receives a DL signal from the upper RS in the second zone 404 of the even-hop RS frame 430. For example, in the second zone 404, the 2-hop RS receives the DL signal from the 1-hop RS.

As such, the odd-hop RS and the even-hop RS switch their operation between the first zone 402 and the second zone 404. A time gap for the operation transition of the RS is inserted between the first zone 402 and the second zone 404 of the odd-hop RS frame 420 and the even-hop RS frame 430.

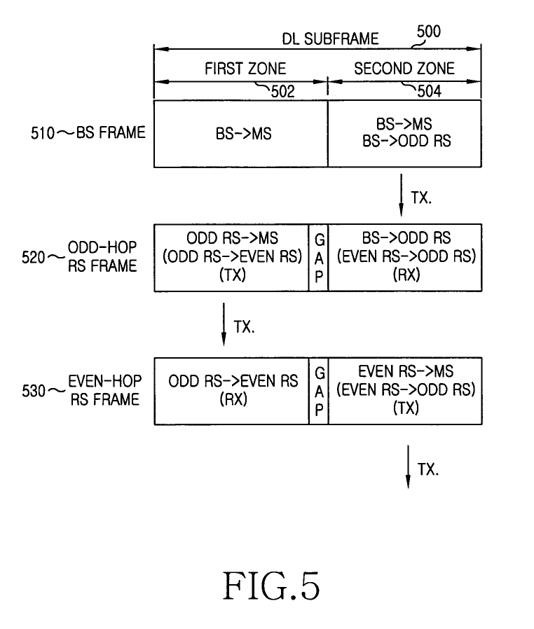

When the wireless communication system is configured in the multiple hops, the wireless communication system may provide the relay service using DL subframes of FIG. 5.

FIG. 5 illustrates DL subframes for the relay service in the wireless communication system according to another exemplary embodiment of the present invention.

The DL subframe 500 of FIG. 5 is divided into a first zone 502 and a second zone 504 using the time resources.

The BS transmits a DL signal to the MS directly communicating, over the first zone 502 of a BS frame 510.

The BS transmits a DL signal to the MS of the direction communication and the 1-hop RS over the second zone 504 of the BS frame 510.

In the first zone 502 of an odd-hop RS frame 520, the odd-hop RS sends a DL signal to the MS of the relay service or the lower RS. For example, in the first zone 502, the 1-hop RS sends the DL signal to the 2-hop RS or the MS of the relay service.

The odd-hop RS receives a DL signal from the BS or the upper RS over the second zone 504 of the odd-hop RS frame 520. For example, in the second zone 504, the 1-hop RS receives a DL signal from the BS and the 3-hop RS receives a DL signal from the 2-hop RS.

The even-hop RS receives a DL signal from the upper RS in the first zone 502 of an even-hop RS frame 530. For example, in the first zone 502, the 2-hop RS receives a DL signal from the 1-hop RS.

The even-hop RS sends a DL signal to the MS of the relay service or the lower RS in the second zone 504 of the even-hop RS frame 530. For example, in the second zone 504, the 2-hop RS sends the DL signal to the 3-hop RS or the MS of the relay service.

As such, the odd-hop RS and the even-hop RS switch their operation between the first zone 502 and the second zone 504. A time gap for the operation transition of the RS is interposed between the first zone 502 and the second zone 504 of the odd-hop RS frame 520 and the even-hop RS frame 530.

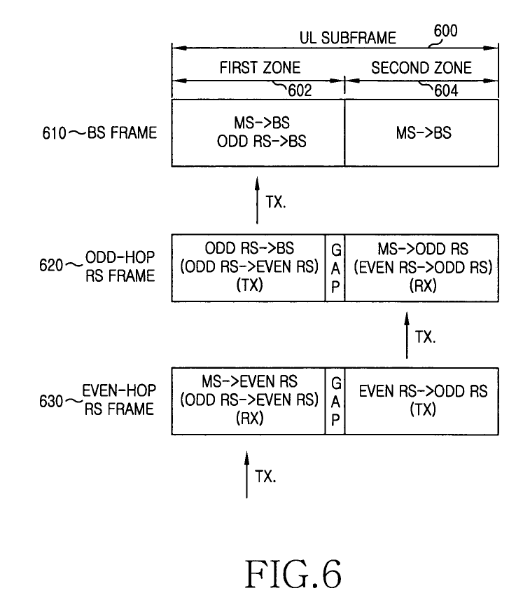

When the wireless communication system includes multiple hops, the wireless communication system offers the relay service using UL subframes of FIG. 6.

FIG. 6 illustrates the UL subframes for the relay service in the wireless communication system according to an exemplary embodiment of the present invention. The UL subframe 600 of FIG. 6 is divided into a first zone 602 and a second zone 604 using the time resources.

The BS receives a UL signal from the MS of the direction communication and the 1-hop RS over the first zone 602 of a BS frame 610.

The BS receives a UL signal from the MS of the direction communication over the second zone 604 of the BS frame 610.

The odd-hop RS sends the UL signal to the BS or the upper RS over the first zone 602 of the odd-hop RS frame 620. For example, in the first zone 602, the 1-hop RS sends the UL signal to the BS and the 3-hop RS sends the UL signal to the 2-hop RS.

Over the second 604 of the odd-hop RS frame 620, the odd-hop RS receives a UL signal from the MS of the relay service or the lower RS. For example, in the second zone 604, the 1-hop RS receives a UL signal from the MS of the relay service or the 2-hop RS.

The even-hop RS receives a signal from the MS of the relay service or the lower RS in the first zone 602 of an even-hop RS frame 630. For example, over the first zone 602, the 2-hop RS receives a UL signal from the MS of the relay service or the 3-hop RS.

The even-hop RS sends the UL signal to the upper RS in the second zone 604 of the even-hop RS frame 630. For example, in the second zone 604, the 2-hop RS sends the UL signal to the 1-hop RS.

As such, the odd-hop RS and the even-hop RS switch their operation between the first zone 602 and the second zone 604. A time gap for the operation transition of the RS is inserted between the first zone 602 and the second zone 604 of the odd-hop RS frame 620 and the even-hop RS frame 630.

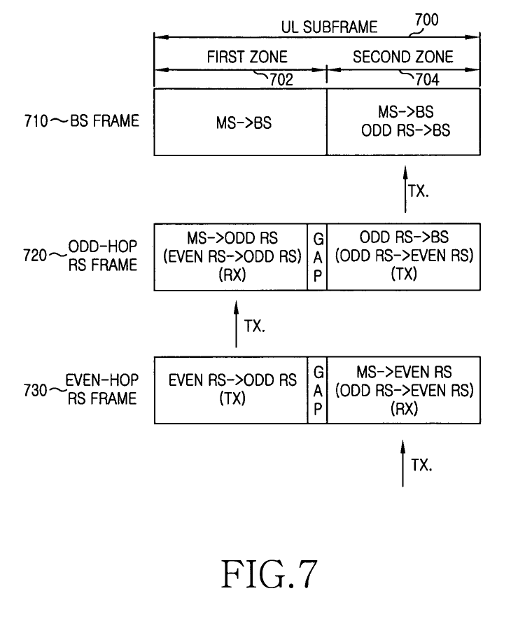

When the wireless communication system includes multiple hops, the wireless communication system can offer the relay service using UL subframes of FIG. 7.

FIG. 7 illustrates the UL subframes for the relay service in the wireless communication system according to another exemplary embodiment of the present invention.

The UL subframe 700 of FIG. 7 is divided into a first zone 702 and a second zone 704 using the time resources.

The BS receives a UL signal from the MS of the direction communication over the first zone 702 of a BS frame 710.

The BS receives a UL signal from the MS of the direction communication and the 1-hop RS over the second zone 704 of the BS frame 710.

The odd-hop RS receives a signal from the MS of the relay service or the lower RS over the first zone 702 of the odd-hop RS frame 720. For example, in the first zone 702, the 1-hop RS receives a UL signal from the MS of the relay service or the 2-hop RS.

Over the second 704 of the odd-hop RS frame 720, the odd-hop RS sends the UL signal to the BS or the upper RS. For example, in the second zone 704, the 1-hop RS sends the UL signal to the BS and 3-hop RS sends the UL signal to the 2-hop RS.

The even-hop RS sends a UL signal to the upper RS over the first zone 702 of an even-hop RS frame 730. For example, in the first zone 702, the 2-hop RS sends the UL signal to the 1-hop RS.

The even-hop RS receive a UL signal from the MS of the relay service or the lower RS over the second zone 704 of the even-hop RS frame 730. For example, in the second zone 704, the 2-hop RS receives a UL signal from the MS of the relay service or the 3-hop RS.

As such, the odd-hop RS and the even-hop RS switch their operation between the first zone 702 and the second zone 704. A time gap for the operation transition of the RS is inserted between the first zone 702 and the second zone 704 of the odd-hop RS frame 720 and the even-hop RS frame 730.

Now, operations of the BS for the relay service in the wireless multihop communication system are described.

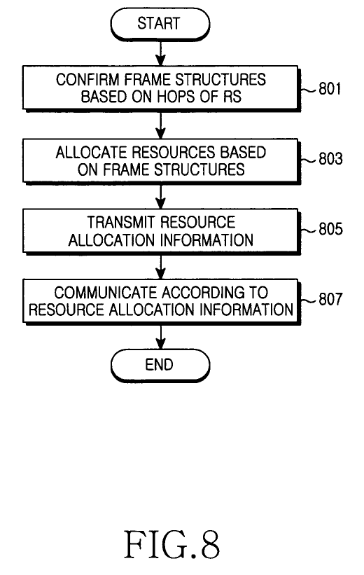

FIG. 8 is a flowchart of the operations of the BS for the relay service in the wireless communication system according to an exemplary embodiment of the present invention.

In step 801, the BS determines the frame structures for the relay service of the RSs based on the number of the hops of the RSs. For example, the frame structures of the even-hop RS and the odd-hop RS are different from each other as shown in FIGS. 4 through 7. Accordingly, the BS confirms the frame structures to be used for the RSs to provide the relay service based on the number of the hops of the RSs.

In step 803, the BS allocates the resources to the RSs by taking into account the frame structures of the RSs. In so doing, the BS also allocates the resources to the serviced MSs.

In step 805, the BS transmits the resource allocation information to the MSs directly communicating with the RSs.

In step 807, the BS communicates in consideration of the resource allocation information. For instance, when the DL subframe is configured as shown in FIG. 5, the BS sends the DL signal to the MS through the resource allocated to the MS over the first zone and the second zone of the DL subframe. The BS sends the DL signal to the RS through the resource allocated to the RS over the second zone of the DL subframe. When the UL subframe is configured as shown in FIG. 7, the BS receives the UL signal from the MS through the resource allocated to the MS over the first zone and the second zone of the UL subframe. The BS receives the UL signal from the RS through the resource allocated to the RS over the second zone of the UL subframe.

Next, the BS finishes this process.

As above, the BS confirms the frame structure to be used for the corresponding RS to offer the relay service by taking into account the number of the hops of the RS. The BS can transmit the frame structure information confirmed based on the hops of the RS, to the RSs. For example, the BS transmits the frame structure information to the RSs using a Downlink Channel Descriptor (DCD) message or Uplink Channel Descriptor (UCD) message, or a separate control message.

Now, operations of the RS for the relay service in the wireless multihop communication system are illustrated.

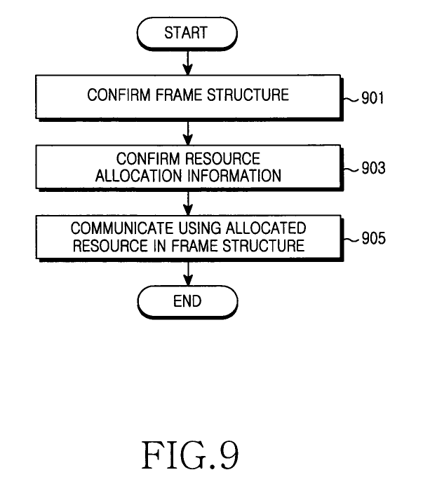

FIG. 9 is a flowchart of the operations of the RS for the relay service in the wireless communication system according to an exemplary embodiment of the present invention.

In step 901, the RS confirms the frame structure to be used to provide the relay service based on the number of the hops to the BS. For example, the RS confirms the frame structure to be used for the relay service in consideration of its hops. Alternatively, the RS can confirm the frame structure to be used for the relay service using the control message received from the BS.

In step 903, the RS confirms the resource allocated from the upper node through the resource allocation information received from the upper node. Herein, the upper node represents the BS or the upper RS.

In step 905, the RS communicates through the resource allocated from the upper node in the frame structure confirmed in step 901.

Next, the RS finishes this process.

A structure of the BS for the relay service in the wireless multihop communication system is now explained.

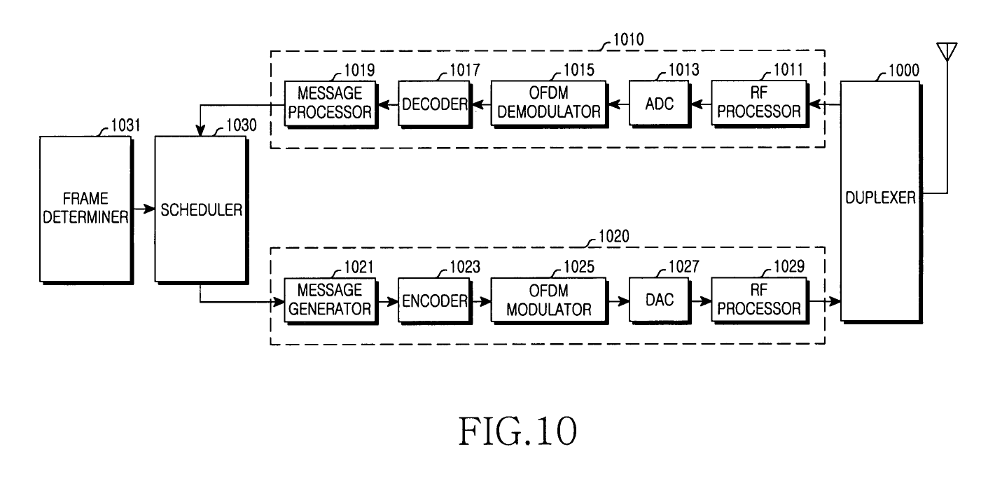

FIG. 10 is a block diagram of the BS in the wireless communication system according to an exemplary embodiment of the present invention.

The BS of FIG. 10 includes a duplexer 1000, a receiver 1010, a transmitter 1020, and a scheduler 1030.

The duplexer 1000 transmits a transmit signal output from the transmitter 1020 over an antenna, and provides a signal received over the antenna to the receiver 1010 in the duplex manner. The duplexer 1000 switches the transmission and the reception under the control of the scheduler 1030.

The receiver 1010 includes a Radio Frequency (RF) processor 1011, an Analog/Digital Converter (ADC) 1013, an Orthogonal Frequency Division Multiplexing (OFDM) demodulator 1015, a decoder 1017, and a message processor 1019.

The RF processor 1011 converts the RF signal output from the duplexer 1000 to a baseband analog signal.

The ADC 1013 converts the analog signal output from the RF processor 1011 to digital sample data.

The OFDM demodulator 1015 converts the digital sample data output from the ADC 1013 to frequency-domain data through a Fast Fourier Transform (FFT).

The decoder 1017 demodulates and decodes the signal output from the OFDM demodulator 1015 at a preset modulation level (Modulation and Coding Scheme (MCS) level).

The message processor 1019 processes the messages received from the lower nodes and outputs the processed messages to the scheduler 1030.

The scheduler 1030 schedules the resources to communicate with the MS in the service coverage and the RS. The scheduler 1030 schedules the resource for the corresponding RS according to the frame information of the RS provided from a frame determiner 1031. For example, the frame structures of the even-hop RS and the odd-hop RS are different from each other as shown in FIGS. 4 through 7. Correspondingly, the scheduler 1030 schedules the resource for the corresponding RS by taking into account the frame structure of the RS to be assigned the resource.

The frame determiner 1031 determines the frame structure of the RS to be used for the relay service by considering the number of the hops of the RSs. For example, the frame determiner 1031 determines the frame structure of the RS depending on the even hops or the odd hops of the RS for the relay service.

The transmitter 1020 includes a message generator 1021, an encoder 1023, an OFDM modulator 1025, a Digital/Analog Converter (DAC) 1027, and an RF processor 1029.

The message generator 1021 generates the resource allocation message including the scheduling information provided from the scheduler 1030. The message generator 1021 generates the message including the frame structure information determined by the frame determiner 1031. For example, the message generator 1021 generates the DCD message, the UCD message, or the separate control message including the frame structure information of the RS.

The encoder 1023 encodes and modulates the transmit signal or the message output from the message generator 1021 at the corresponding modulation level (MCS level).

The OFDM modulator 1025 converts the encoded and modulated signal output from the encoder 1023 to time-domain sample data (OFDM symbols) through Inverse FFT (IFFT).

The DAC 1027 converts the sample data output from the OFDM modulator 1025 to an analog signal.

The RF processor 1029 converts the analog signal output from the DAC 1027 to an RF signal.

The following explanation provides a structure of the RS for the relay service in the wireless multihop communication system.

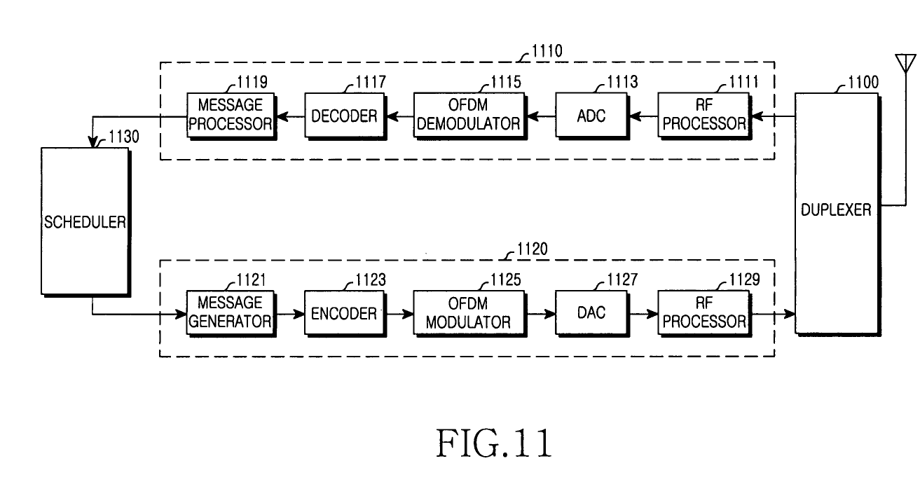

FIG. 11 is a block diagram of the RS in the wireless communication system according to an exemplary embodiment of the present invention.

The RS of FIG. 11 includes a duplexer 1100, a receiver 1110, a transmitter 1120, and a scheduler 1130.

The duplexer 1100 transmits a transmit signal output from the transmitter 1120 over an antenna, and provides a signal received over the antenna to the receiver 1110 in the duplex manner. The duplexer 1100 switches the transmission and the reception under the control of the scheduler 1130.

The receiver 1110 includes an RF processor 1111, an ADC 1113, an OFDM demodulator 1115, a decoder 1117, and a message processor 1119.

The RF processor 1111 converts the RF signal output from the duplexer 1100 to a baseband analog signal.

The ADC 1113 converts the analog signal output from the RF processor 1111 to digital sample data.

The OFDM demodulator 1115 converts the digital sample data output from the ADC 1113 to frequency-domain data through the FFT.

The decoder 1117 demodulates and decodes the signal output from the OFDM demodulator 1115 at a preset modulation level (MCS level).

The message processor 1119 extracts the control information from the signal output from the decoder 1117 and outputs the extracted control information to the scheduler 1130. For example, the message processor 1119 extracts the control message including the frame structure information and the resource allocation information from the signal output from the decoder 1117 and provides the extracted control message to the scheduler 1130.

The scheduler 1130 controls the RS to provide the relay service through the resource allocated from the upper node. For instance, the scheduler 1130 acquires the frame structure information to be used for the relay service and the resource information allocated from the upper node through the control messages fed from the message processor 1119. Next, the scheduler 1130 controls the RS to provide the relay service through the resource allocated from the upper node in the acquired frame structure. Alternatively, the scheduler 1130 confirms the frame structure to be used for the relay service by taking into account the number of the hops of the BS. The scheduler 1130 acquires the resource information allocated from the upper node through the control message fed from the message processor 1119. Next, the scheduler 1130 can control the RS to provide the relay service through the resource allocated from the upper node in the confirmed frame structure.

The scheduler 1130 controls the duplexer 1100 according to the frame structure to be used for the relay service.

The transmitter 1120 includes a message generator 1121, an encoder 1123, an OFDM modulator 1125, a DAC 1127, and an RF processor 1129.

The message generator 1121 generates the control message to be sent to the upper node or the lower node under the control of the scheduler 1130.

The encoder 1123 encodes and modulates the transmit signal or the control message output from the message generator 1121 at the corresponding modulation level (MCS level).

The OFDM modulator 1125 converts the encoded and modulated signal output from the encoder 1123 to time-domain sample data (OFDM symbols) through the IFFT.

The DAC 1127 converts the sample data output from the OFDM modulator 1125 to an analog signal. The RF processor 1129 converts the analog signal output from the DAC 1127 to an RF signal.

In one embodiment, the wireless communication system configures the frames such that the even-hop RS and the odd-hop RS classified based on the number of the hops offer the relay service using the different frame structures.

Alternatively, regardless of the number of the hops of the RSs, the wireless communication system can classify the RSs of the relay service to a first RS set and a second RS set. In this case, the wireless communication system configures the frames such that the first RS set and the second RS set provide the relay service using the different frame structures. For example, the wireless communication system can configure the same frame structures of the first RS set and the second RS set as the even-hop RS and the odd-hop RS.

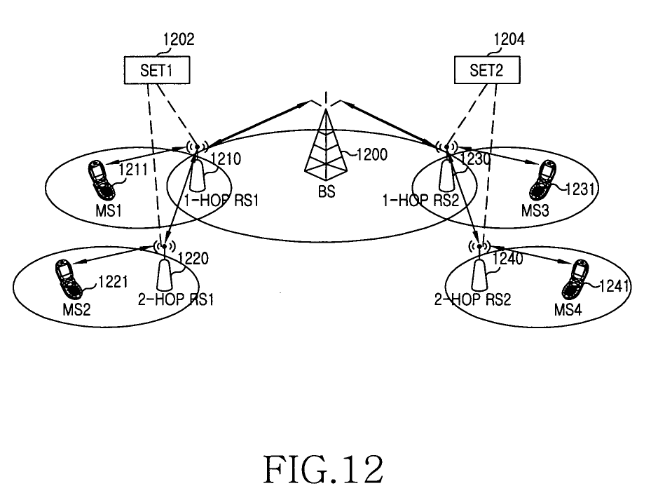

When the RS sets are used regardless of the number of the hops of the RSs as above, the wireless communication system can divide the RSs for the relay service to the first RS set and the second RS set as shown in FIG. 12.

FIG. 12 illustrates the RS sets in the wireless multihop communication system according to an exemplary embodiment of the present invention.

The wireless communication system of FIG. 12 includes a BS 1200, RSs 1210 through 1240, and MSs 1211 through 1241.

The BS 1200 services the MSs 1211 through 1241 via the RSs 1210 through 1240.

The BS 1200 generates the first RS set 1202 with the first 1-hop RS 1210 connected to the BS 1200 and the first 2-hop RS 1220 connected to the first 1-hop RS 1210. The BS 1200 generates the second RS set 1204 with the second 1-hop RS 1230 connected to the BS 1200 and the second 2-hop RS 1240 connected to the second 1-hop RS 1230.

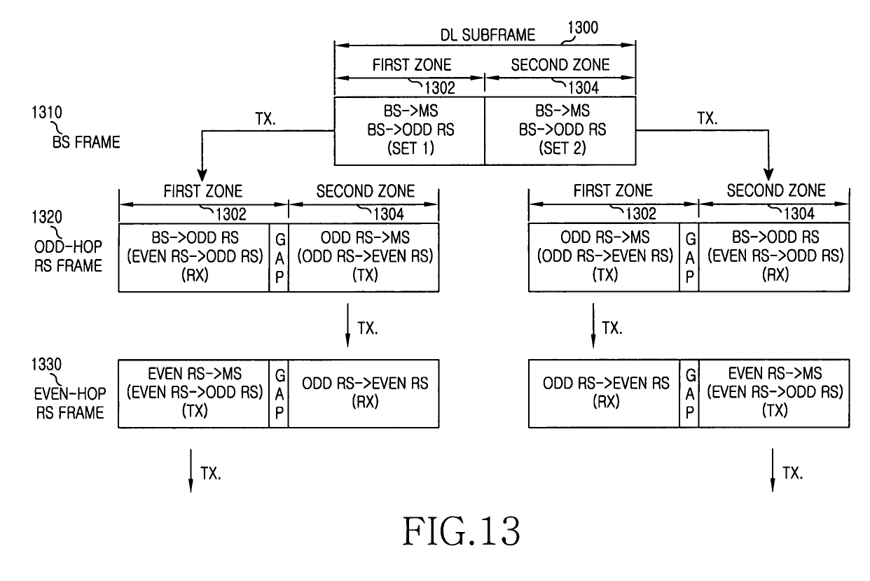

With the RS sets as above, the wireless communication system offers the relay service using DL subframes of FIG. 13.

FIG. 13 illustrates the DL subframes according to the RS sets in the wireless communication system according to an exemplary embodiment of the present invention.

The DL subframe 1300 of FIG. 13 is divided into a first zone 1302 and a second zone 1304 using the time resources.

Over the first zone 1302 of the BS frame 1310, the BS sends a DL signal to the MS of the direct communication and the 1-hop RS of the first RS set. That is, the BS sends the DL signals to the RSs of the first RS set in the first zone 1302.

Over the second zone 1304 of the BS frame 1310, the BS sends DL signals to the MS of the direct communication and the 1-hop RS of the first RS set. That is, the BS sends DL signals to the RSs of the second RS set over the second zone 1304.

As in FIG. 4 or FIG. 5, the odd-hop RS and the even-hop RS of the first RS set provide the relay service using different DL subframes.

The odd-hop RS of the first RS set receives a DL signal from the BS or the upper RS over the first zone 1302 of the odd-hop RS frame 1320. For example, in the first zone 1302, the 1-hop RS receives the DL signal from the BS and the 3-hop RS receives the DL signal from the 2-hop RS.

Over the second zone 1304 of the odd-hop RS frame 1320, the odd-hop RS sends the DL signal to the MS of the relay service or the lower RS. For example, in the second zone 1304, the 1-hop RS sends the DL signal to the 2-hop RS or the MS of the relay service.

In the first zone 1302 of the even-hop RS frame 1330, the even-hop RS of the first RS set sends a DL signal to the MS of the relay service or the lower RS. For example, in the first zone 1302, the 2-hop RS sends the DL signal to the 3-hop RS or the MS of the relay service.

In the second zone 1304 of the even-hop RS frame 1330, the even-hop RS receives a DL signal from the upper RS. For example, over the second zone 1304, the 2-hop RS receives a DL signal from the 1-hop RS.

The odd-hop RS and the even-hop RS of the second RS set offer the relay service using different DL subframes as in FIG. 4 or FIG. 5.

The odd-hop RS of the second RS set sends a DL signal to the MS of the relay service or the lower RS over the first zone 1302 of the odd-hop RS frame 1320. For example, in the first zone 1302, the 1-hop RS sends a DL signal to the 2-hop RS or the MS of the relay service.

Over the second zone 1304 of the odd-hop RS frame 1320, the odd-hop RS receives a DL signal from the BS or the upper RS. For example, in the second zone 1304, the 1-hop RS receives the DL signal from the BS and the 3-hop RS receives the DL signal from the 2-hop RS.

Over the first zone 1302 of the even-hop RS frame 1330, the even-hop RS of the second RS set receives a DL signal from the upper RS. For example, in the first zone 1302, the 2-hop RS receives a DL signal from the 1-hop RS.

Over the second zone 1304 of the even-hop RS frame 1330, the even-hop RS sends the DL signal to the MS of the relay service or the lower RS. For example, in the second zone 1304, the 2-hop RS sends the DL signal to the 3-hop RS or the MS of the relay service.

There is a time gap for the operation transition of the RS between the first zone 1302 and the second zone 1304 of the odd-hop RS frame 1320 and the even-hop RS frame 1330.

As such, the RSs of the first RS set and the second RS set switch their operation between the first zone 1302 and the second zone 1304. For doing so, there is a time gap for the operation transition of the RS between the first zone 1302 and the second zone 1304 of the odd-hop RS frame 1320 and the even-hop RS frame 1330.

In one embodiment, the RSs of the first RS set provide the relay service using the DL subframe structure of FIG. 4 and the RSs of the second RS set provide the relay service using the DL subframe structure of FIG. 5.

Alternatively, the RSs of the first RS set can offer the relay service using the DL subframe structure of FIG. 5 and the RSs of the second RS set can offer the relay service using the DL subframe structure of FIG. 4.

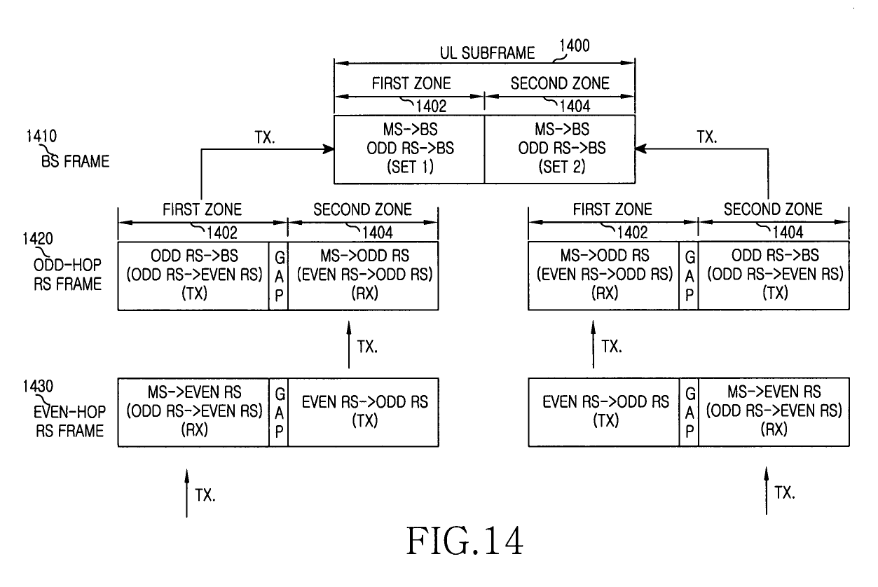

With the RS sets of FIG. 12, the wireless communication system provides the relay service using UL subframes of FIG. 14.

FIG. 14 illustrates the UL subframes according to the RS sets in the wireless communication system according to an exemplary embodiment of the present invention.

The UL subframe 1400 of FIG. 14 is divided into a first zone 1402 and a second zone 1404 using the time resources.

Over the first zone 1402 of the BS frame 1410, the BS receives UL signals from the MS of the direct communication and the 1-hop RS of the first RS set. That is, the BS receives UL signals from the RSs of the first RS set over the first zone 1402.

Over the second zone 1404 of the BS frame 1410, the BS receives UL signals from the MS of the direct communication and the 1-hop RS of the second RS set. That is, the BS receives UL signals from the RSs of the second RS set over the second zone 1404.

The odd-hop RS and the even-hop RS of the first RS set offer the relay service using different UL subframes as in FIG. 6 or FIG. 7.

Over the first zone 1402 of the odd-hop RS frame 1420, the odd-hop RS of the first RS set sends a UL signal to the BS or the upper RS. For example, in the first zone 1402, the 1-hop RS sends the UL signal to the BS and the 3-hop RS sends the UL signal to the 2-hop RS.

Over the second zone 1404 of the odd-hop RS frame 1420, the odd-hop RS receives a UL signal from the MS of the relay service or the lower RS. For example, in the second zone 1404, the 1-hop RS receives the UL signal from the MS of the relay service or the 2-hop RS.

Over the first zone 1402 of the even-hop RS frame 1430, the even-hop RS of the first RS set receives a signal from the MS of the relay service or the lower RS. For example, in the first zone 1402, the 2-hop RS receives the UL signal from the MS of the relay service or the 3-hop RS.

Over the second zone 1404 of the even-hop RS frame 1430, the even-hop RS sends the UL signal to the upper RS. For example, in the second zone 1404, the 2-hop RS sends the UL signal to the 1-hop RS.

The odd-hop RS and the even-hop RS of the second RS set offer the relay service using different UL subframe structures as in FIG. 6 or FIG. 7.

Over the first zone 1402 of the odd-hop RS frame 1420, the odd-hop RS of the second RS set receives a signal from the MS of the relay service or the lower RS. For example, in the first zone 1402, the 1-hop RS receives the UL signal from the MS of the relay service or the 2-hop RS.

Over the second zone 1404 of the odd-hop RS frame 1420, the odd-hop RS sends a UL signal to the BS or the upper RS. For example, in the second zone 1404, the 1-hop RS sends the UL signal to the BS and the 3-hop RS sends the UL signal to the 2-hop RS.

Over the first zone 1402 of the even-hop RS frame 1430, the even-hop RS of the second RS set sends a UL signal to the upper RS. For example, in the first zone 1402, the 2-hop RS sends the UL signal to the 1-hop RS.

Over the second zone 1404 of the even-hop RS frame 1430, the even-hop RS receives a UL signal from the MS of the relay service or the lower RS. For example, in the second zone 1404, the 2-hop RS receives the UL signal from the MS of the relay service or the 3-hop RS.

As such, the RSs of the first RS set and the second RS set switch their operation between the first zone 1402 and the second zone 1404. For doing so, there is a time gap for the operation transition of the RS between the first zone 1402 and the second zone 1404 of the odd-hop RS frame 1420 and the even-hop RS frame 1430.

In one embodiment, the RSs of the first RS set provide the relay service using the DL subframe of FIG. 6 and the RSs of the second RS set provide the relay service using the DL subframe of FIG. 7.

Alternatively, the RSs of the first RS set can offer the relay service using the DL subframe of FIG. 7 and the RSs of the second RS set can offer the relay service using the DL subframe of FIG. 6.

Hereafter, the operations of the BS for the relay service are described using the RS sets of FIG. 12. It is assumed that the BS provides the relay service using the DL subframe of FIG. 13 and the UL subframe of FIG. 14.

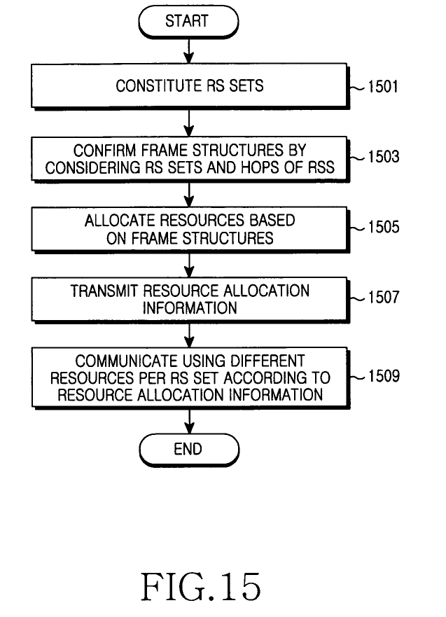

FIG. 15 is a flowchart of the operations of the BS for the relay service in the wireless communication system according to another exemplary embodiment of the present invention.

In step 1501, the BS generates two or more RS sets by dividing a plurality of RSs. For example, the BS generates the RS sets by taking into account interference between the RSs or the data transmission amount of the RSs. The BS can determine the RS set at the point of the initial access of the RS, or generate a new RS set during the communication with the RS.

In step 1503, the BS confirms the frame structures for the relay services of the RSs according to the RS set of the RSs and the hops of the RSs. For instance, as shown in FIGS. 13 and 14, the frame structures of the even-hop RS and the odd-hop RS are different from each other, the frame structures of the odd-hop RSs of the first RS set and the second RS set are different from each other, and the frame structures of the even-hop RSs of the first RS set and the second RS set are different from each other. Depending on the RS set of the RSs and the hops of the RSs, the BS confirms the frame structures to be used for the RSs to provide the relay service.

In step 1505, the BS allocates the resources for the RSs by considering the frame structures of the RSs. The BS also allocates the resources for the serviced MSs.

In step 1507, the BS transmits the resource allocation information of the RSs to the MSs that communicate directly with the RSs. For instance, given the DL subframe of FIG. 13, the BS transmits the resource allocation information on the RS set basis. More specifically, the BS transmits the resource allocation information of the RSs of the first RS set over the first zone 1302 of the DL subframe 1300 and the resource allocation information of the RSs of the second RS set over the second zone 1304 of the DL subframe.

In step 1509, the BS communicates using the resources allocated to the RS sets. For example, given the DL subframe of FIG. 13, the BS transmits the DL signal to the MS through the resource allocated to the MS in the first zone and the second zone of the BS frame. In the first zone of the DL subframe, the BS transmits the DL signal to the corresponding RS through the resource allocated to the RS of the first RS set. In the second zone of the DL subframe, the BS transmits the DL signal to the corresponding RS through the resource allocated to the RS of the second RS set. Meanwhile, given the UL subframe of FIG. 14, the BS receives the UL signal from the MS through the resource allocated to the MS in the first zone and the second zone of the BS frame. Over the first zone of the UL subframe, the BS receives the UL signal from the corresponding RS through the resource allocated to the RS of the first RS set. Over the second zone of the UL subframe, the BS receives the UL signal from the corresponding RS through the resource allocated to the RS of the second RS set.

Next, the BS finishes this process.

In one embodiment, the BS confirms the frame structure used for the corresponding RS to provide the relay service by considering the RS set and the hops of the RS. The BS can transmit the confirmed frame structure information to the RSs. For instance, the BS transmits the frame structure information to the RSs using the DCD message, the UCD message, or the separate control message.

Alternatively, the wireless communication system can confirm the frame structure to be used for the corresponding RS to provide the relay service by taking into account only the RS set according to the RS set constitution manner.

Descriptions provide the operations of the RS for the relay service using the RS sets of FIG. 12. It is assumed that the RS offers the relay service using the DL subframe of FIG. 13 and the UL subframe of FIG. 14.

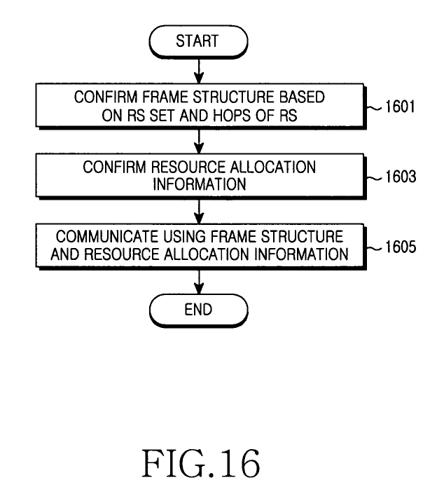

FIG. 16 is a flowchart of the operations of the RS for the relay service in the wireless communication system according to another exemplary embodiment of the present invention.

In step 1601, the RS confirms the frame structure to be used for the relay service determined based on the hops to the BS and its RS set. For example, the RS confirms the frame structure to be used for the relay service by considering the hops to the BS and its RS set information based on the control message received from the upper node. Alternatively, the RS can confirm the frame structure to be used for the relay service through the control message received from the upper node.

In step 1603, the RS confirms the resource allocated from the upper node through the resource allocation information received from the upper node.

In step 1605, the RS communicates through the resource allocated from the upper node in the frame structure confirmed in step 1601. For example, using the DL subframe of FIG. 13 and the UL subframe of FIG. 14, the odd-hop RS of the first RS set communicates with the upper node through the resource allocated from the upper node over the first zone of the UL/DL subframe. The even-hop RS of the first RS set communicates with the lower node through the resource allocated from the upper node over the second zone of the UL/DL subframe. Meanwhile, the odd-hop RS of the second RS set communicates with the upper node through the resource allocated from the lower node over the first zone of the UL/DL subframe. The even-hop RS of the second RS set communicates with the upper node through the resource allocated from the upper node over the second zone of the UL/DL subframe.

Next, the RS finishes this process.

With the RS sets as aforementioned, the BS of the wireless communication system further includes a set configurer in FIG. 10 for configuring the RS set by taking into account the interference between the RSs and the data transmission amount of the RSs. In this situation, the frame determiner 1031 determines the frame structure of the RS for the relay service by considering the RS set and the hops.

The scheduler 1130 of the RS in FIG. 11 can confirm the frame structure to be used for the relay service by taking into account the RS set and the hops to the BS.

So far, it has been assumed that the wireless communication system provides one communication service using the multihop.

Alternatively, when the communication services of other standards can be provided, the wireless communication system can constitute the various communication services as different sets. At this time, each set can offer the service using the same frame structure as the RS set.

In the light of the foregoing, the wireless communication system provides the multihop relay service by use of the different frame structures based on the number of the hops of the RS. Therefore, the frames for the multihop relay service can be constituted with ease, the multihop relay service can be provided not to drive the relay service data into a particular part of the frame, and the service coverage of the MS can be extended.

Although the present disclosure has been described with an exemplary embodiment, various changes and modifications may be suggested to one skilled in the art. It is intended that the present disclosure encompass such changes and modifications as fall within the scope of the appended claims

What is claimed is:

1. A method for constituting a frame for a relay service in a wireless communication system, the method comprising:
configuring a Downlink (DL) subframe for at a Base Station (BS) to transmit a signal to a Mobile Station (MS) over a first zone of the DL subframe and to transmit a signal to the MS or a lower Relay Station (RS) over a second zone;
configuring an UpLink (UL) subframe for at the BS to receive a signal from the MS over a first zone of the UL subframe and to receive a signal from the MS or the lower RS over a second zone;
configuring a DL subframe for an odd-hop RS to transmit a signal to an MS or a lower even-hop RS over a first zone of the DL subframe and to receive a signal from an upper node over a second zone;
configuring a UL subframe for the odd-hop RS to receive a signal from an MS or a lower even-hop RS over a first zone of the UL subframe and to transmit a signal to an upper node over a second zone;
configuring a DL subframe for an even-hop RS to receive a signal from an upper node over a first zone of the DL subframe and to transmit a signal to an MS or a lower odd-hop RS over a second zone; and
configuring a UL subframe for the even-hop RS to transmit a signal to an upper node over a first zone of the UL subframe and to receive a signal from an MS or a lower odd-hop RS over a second zone.

2. The method of claim 1, wherein the odd-hop RS and the even-hop RS are determined based on the number of hops to the BS.

3. The method of claim 1, wherein the upper node is the BS or the upper RS.

4. A method for a relay service at a Relay Station (RS) in a wireless communication system, the method comprising:
confirming a frame structure to be used to provide a relay service by taking into account of the number of hops to a Base Station (BS);
transmitting, at an odd-hop RS, a signal to a Mobile Station (MS) or a lower even-hop RS over a first zone of a DownLink (DL) subframe and receiving a signal from an upper node over a second zone according to the confirmed frame structure;
receiving, at the odd-hop RS, a signal from an MS or a lower even-hop RS over a first zone of an UpLink (UL) subframe and transmitting a signal to an upper node over a second zone;
receiving, at an even-hop RS, a signal from an upper node over a first zone of a DL subframe and transmitting a signal to an MS or a lower odd-hop RS over a second zone according to the confirmed frame structure; and
transmitting, at the even-hop RS, a signal to an upper node over a first zone of the UL subframe and receiving a signal from the MS or the lower odd-hop RS over a second zone.

5. The method of claim 4, wherein the upper node is the BS or an upper. RS.

6. The method of claim 4, further comprising, before confirming the frame structure:
confirming a set of the RS.

7. The method of claim 6, wherein the confirming of the frame structure comprises:
confirming the frame structure to be used for the relay service by taking into account the number of hops to the BS per set,
wherein, when the RS belongs to a first set, a signal is received from the upper node over the second zone.

8. The method of claim 7, further comprising, after the confirming of the frame structure:
receiving, at an odd-hop RS belonging to a second set, a signal from an upper node over a first zone of a DL subframe and transmitting a signal to an MS or a lower even-hop RS over a second zone according to the confirmed frame structure;
transmitting, at the odd-hop RS belonging to the second set, a signal to the upper node over a first zone of a UL subframe and receiving a signal from the MS or the lower even-hop RS over a second zone;
transmitting, at an even-hop RS belonging to the second set, a signal to an MS or a lower odd-hop RS over a first zone of a DL subframe and receiving a signal from an upper node over a second zone according to the confirmed frame structure; and
receiving, at the even-hop RS belonging to the second set, a signal from the MS or the lower odd-hop RS over a first zone of a UL subframe and transmitting a signal to the upper node over a second zone.

9. The method of claim 4, wherein the confirming of the frame structure comprises:
confirming frame structure information determined by the BS in consideration of the number of hops to the RS, through a control message received from the upper node.

10. A method for a relay service at a Base Station (BS) in a wireless communication system, the method comprising:
confirming frame structures to be used for Relay Stations (RSs) to provide the relay service by taking into account of the number of hops of at least one RS;
allocating resources for the RSs by taking into account the frame structures of the RSs;
transmitting resource allocation information to the RSs; and
communicating with a Mobile Station (MS) or the RS according to the resource allocation information.

11. The method of claim 10, further comprising, after the confirming of the frame structures:
transmitting the confirmed frame structure information to the RS.

12. The method of claim 10, further comprising, before the confirming of the frame structures:
confirming sets of the RSs,
wherein the frame structures to be used for the RSs to provide the relay service are confirmed by taking into account the number of hops of the RS per set.

13. The method of claim 10, wherein the communicating comprises:
transmitting a signal to an MS over a first zone of a DownLink (DL) subframe;
transmitting a signal to the MS or a lower RS over a second zone of the DL subframe;
receiving a signal from the MS over a first zone of an UpLink (UL) subframe; and
receiving a signal from the MS or the lower RS over a second zone of the UL subframe.

14. An apparatus for a relay service at a Relay Station (RS) in a wireless communication system, the apparatus comprising:
a scheduler for controlling transmission and reception of signals according to a frame structure determined based on the number of hops to a Base Station (BS);
a receiver for, in an odd-hop RS, receiving a signal from an upper node over a second zone of a DownLink (DL) subframe and receiving a signal from a Mobile Station (MS) or a lower even-hop RS over a first zone of an UpLink (UL) subframe under control of the scheduler, and, in an even-hop RS, receiving a signal from an upper node over a first zone of the DL subframe and receiving a signal from the MS or a lower odd-hop RS over a second zone of the UL subframe under the control of the scheduler; and
a transmitter for, in the odd-hop RS, transmitting a signal to the MS or the lower even-hop RS over the first zone of the DL subframe and transmitting a signal to the upper node over the second zone of the UL subframe under the control of the scheduler, and, in the even-hop RS, transmitting a signal to the MS or the lower odd-hop RS over the second zone of the DL subframe and transmitting a signal to the upper node over the first zone of the UL subframe under the control of the scheduler.

15. The apparatus of claim 14, wherein the upper node is the BS or an upper RS.

16. The apparatus of claim 14, wherein the scheduler controls the transmission and the reception of the signals according to the frame structure determined based on the number of the hops to the BS and resource allocation information provided from the upper node.

17. The apparatus of claim 14, wherein the scheduler controls the signal transmission and reception according to a set of the RS and the frame structure determined based on the number of hops to the BS.

18. The apparatus of claim 17, wherein the receiver, in an odd-hop RS belonging to a first set, receives a signal from the upper node over the second zone of the DL subframe and receives a signal from the MS or the lower even-hop RS over the first zone of the UL subframe under the control of the scheduler, and, in an even-hop RS, the receiver receives a signal from the upper node over the first zone of the DL subframe and receives a signal from the MS or the lower odd-hop RS over the second zone of the UL subframe under the control of the scheduler,
in an odd-hop RS belonging to a second set, the receiver receives a signal from an upper node over the first zone of the DL subframe and receives a signal from the MS or a lower even-hop RS over the second zone of the UL subframe under the control of the scheduler, and, in an even-hop RS, the receiver receives a signal from an upper node over the second zone of the DL subframe and receives a signal from an MS or a lower odd-hop RS over the first zone of the UL subframe under the control of the scheduler.

19. The apparatus of claim 17, wherein, in an odd-hop RS belonging to a first set, the transmitter sends a signal to an MS or a lower even-hop RS over the first zone of the DL subframe and sends a signal to an upper node over the second zone of the UL subframe under the control of the scheduler, and, in an even-hop RS, the transmitter sends a signal to an MS or a lower odd-hop RS over the second zone of the DL subframe and sends a signal to an upper node over the first zone of the UL subframe under the control of the scheduler,
in an odd-hop RS belonging to a second set, the transmitter sends a signal to an MS or a lower even-hop RS over the second zone of the DL subframe and sends a signal to an upper node over the first zone of the UL subframe under the control of the scheduler, and, in an even-hop RS, the transmitter sends a signal to an MS or a lower odd-hop RS over the first zone of the DL subframe and sends a signal to an upper node over the second zone of the UL subframe under the control of the scheduler.

20. An apparatus for a relay service at a Base Station (BS) in a wireless communication system, the apparatus comprising:
a frame determiner for confirming frame structures to be used for Relay Stations (RSs) to provide the relay service by taking into account of the number of hops of at least one RS;
a scheduler for allocating resources for the RSs by taking into account the frame structures of the RSs;
a transmitter for transmitting resource allocation information to the RSs, and sending a signal to a Mobile Station (MS) or an RS according to the resource allocation information; and
a receiver for receiving a signal from the MS or the RS according to the resource allocation information.

21. The apparatus of claim 20, wherein the transmitter sends a signal to the MS over a first zone of a DownLink (DL) subframe and sends a signal to the MS or a lower RS over a second zone of the DL subframe according to the resource allocation information.

22. The apparatus of claim 20, wherein the transmitter transmits frame structure information confirmed at the frame determiner, to the RS.

23. The apparatus of claim 20, wherein the receiver receives a signal from the MS over a first zone of an UpLink (UL) subframe and receives a signal from the MS or the lower RS over a second zone of the UL subframe according to the resource allocation information.

24. The apparatus of claim 20, further comprising:
a set configurer for configuring RS sets by taking into account interference between the RSs or data transmission amount of the RSs,
wherein the frame determiner confirms the frame structures to be used for the RSs to provide the relay service by taking into account the set of the RS and the number of hops of the RS.
